(19) United States
(12) Patent Application Publication
(10) Pub. No.: US 2026/0021767 A1
(43) Pub. Date: Jan. 22, 2026

(54) VEHICLE DISPLAY CONTROL DEVICE

(71) Applicant: TOYOTA JIDOSHA KABUSHIKI KAISHA, Toyota-shi (JP)

(72) Inventor: Miki TSUJINO, Ichinomiya-shi (JP)

(73) Assignee: TOYOTA JIDOSHA KABUSHIKI KAISHA, Toyota-shi (JP)

(21) Appl. No.: 19/084,922

(22) Filed: Mar. 20, 2025

(30) Foreign Application Priority Data
Jul. 19, 2024 (JP) 2024-116233

(51) Int. Cl. B60R 1/27; B60K 35/22; B60K 35/234; B60R 1/24; B60W 60/00

(52) U.S. Cl. CPC B60R 1/27; B60R 1/24; B60K 35/22; B60K 35/234; B60R 2300/205; B60R 2300/307; B60R 2300/607; B60R 2300/806; B60W 60/00

(57) ABSTRACT

The vehicle display control device includes a display control unit configured to display, on a first display area provided around a driver's seat of the host vehicle, a peripheral image simulating a peripheral state of the host vehicle and an area image indicating an area in which the host vehicle can be parked on the peripheral image, and to display, on a second display area provided at a place different from the first display area around the driver's seat, area information that is information corresponding to the area image in correspondence with the peripheral state of the host vehicle.

### CROSS-REFERENCE TO RELATED APPLICATION

This application claims priority to Japanese Patent Application No. 2024-116233 filed on Jul. 19, 2024. The disclosure of the above-identified application, including the specification, drawings, and claims, is incorporated by reference herein in its entirety.

### BACKGROUND

### 1. Technical Field

The disclosed technology relates to a vehicle display control device.

### 2. Description of Related Art

Japanese Patent No. 7048398 discloses a vehicle control device capable of performing autonomous driving that gives a sense of security to an occupant. The vehicle control device includes a display unit, a recognition unit, a driving control unit, and a display control unit. The display unit displays an image. The recognition unit recognizes an object including another vehicle. The driving control unit generates a target track of the host vehicle based on the state of the object, and controls at least one of the speed or the steering of the host vehicle based on the target track. The display control unit causes the display unit to display a first image that resembles another vehicle and a second image that resembles the target track as superimposed on a third image that resembles a road on which the host vehicle is present. The second image is an image in which a first section is displayed in a highlighted manner as compared with a second section, among a plurality of sections obtained by dividing the target track with respect to the length direction. The first section is a section on the front side, as viewed from the host vehicle, with respect to a reference vehicle referenced when generating the target track. The second section is a section on the back side with respect to the reference vehicle as viewed from the host vehicle.

### SUMMARY

When parking the host vehicle, it is sometimes difficult for the occupant to correctly recognize which parking position in the actual surrounding situation of the host vehicle is the recommended parking position indicated on an image simulating the surrounding situation of the host vehicle.

An object of the disclosed technology is to provide a vehicle display control device capable of allowing an occupant to correctly recognize the actual recommended parking position.

A first aspect provides a vehicle display control device including a display control unit that displays a peripheral image simulating a peripheral situation of a host vehicle and an area image indicating an area that enables the host vehicle to be parked on the peripheral image in a first display area provided around a driver's seat of the host vehicle, and that displays area information that is information corresponding to the area image in correspondence with the peripheral situation of the host vehicle in a second display area provided at a location different from the first display area around the driver's seat.

Therefore, according to the vehicle display control device of the first aspect, it is possible to allow an occupant to correctly recognize the actual recommended parking position.

A second aspect provides the vehicle display control device according to the first aspect, in which the display control unit displays the area image and the area information in at least partially the same manner.

Therefore, according to the vehicle display control device of the second aspect, the occupant can easily understand the correspondence relationship between the area image and the area information displayed in the different display areas.

A third aspect provides the vehicle display control device according to the first or second aspect, in which: the display control unit displays, in a specific color, the area image indicating a first recommended area in which parking of the host vehicle is recommended and the area information corresponding to the area image indicating the first recommended area, the first recommended area being determined based on information about the peripheral situation from among a plurality of areas; and the display control unit displays, in a color different from the specific color, the area image indicating a second recommended area in which parking of the host vehicle is recommended and the area information corresponding to the area image indicating the second recommended area, the second recommended area being different from the first recommended area.

Therefore, according to the vehicle display control device of the third aspect, the occupant can easily understand the correspondence relationship between pieces of information indicating parkable areas having different levels of recommendation displayed in the different display areas.

A fourth aspect provides the vehicle display control device according to any one of the first to third aspects, in which the display control unit displays a marker indicating a direction in which the area is present in the second display area when the area is located outside a displayable range of the second display area.

Therefore, according to the vehicle display control device of the fourth aspect, it is possible to provide guidance on the parkable area deviating from the displayable range as superimposed on the view ahead of the host vehicle.

A fifth aspect provides the vehicle display control device according to any one of the first to fourth aspects, further including a function control unit that controls a state of an operation function related to parking of the host vehicle based on an operation on a function image indicating the operation function, in which the display control unit displays the function image in the first display area, and moves display of the function image in accordance with an operation on the function image.

Therefore, according to the vehicle display control device of the fifth aspect, the occupant can easily control the state of the operation function at the time of automatic parking.

According to the disclosed technology, it is possible to allow an occupant to correctly recognize the actual recommended parking position.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a hardware configuration of a vehicle display control device according to an embodiment;

FIG. 2 is a block diagram illustrating a functional configuration of the vehicle display control device according to the embodiment;

FIG. 3A is a diagram illustrating an example of a display screen of a second display unit according to an embodiment;

FIG. 3B is a diagram illustrating an example of a display screen of a first display unit according to an embodiment;

FIG. 4A is a diagram illustrating an example of a display screen of a second display unit according to an embodiment;

FIG. 4B is a diagram illustrating an example of a display screen of a first display unit according to an embodiment;

FIG. 5 is a flow chart illustrating an exemplary flow of the displaying process according to the embodiment; and

FIG. 6 is a flowchart illustrating an example of a flow of function control processing according to the embodiment.

### DETAILED DESCRIPTION OF EMBODIMENTS

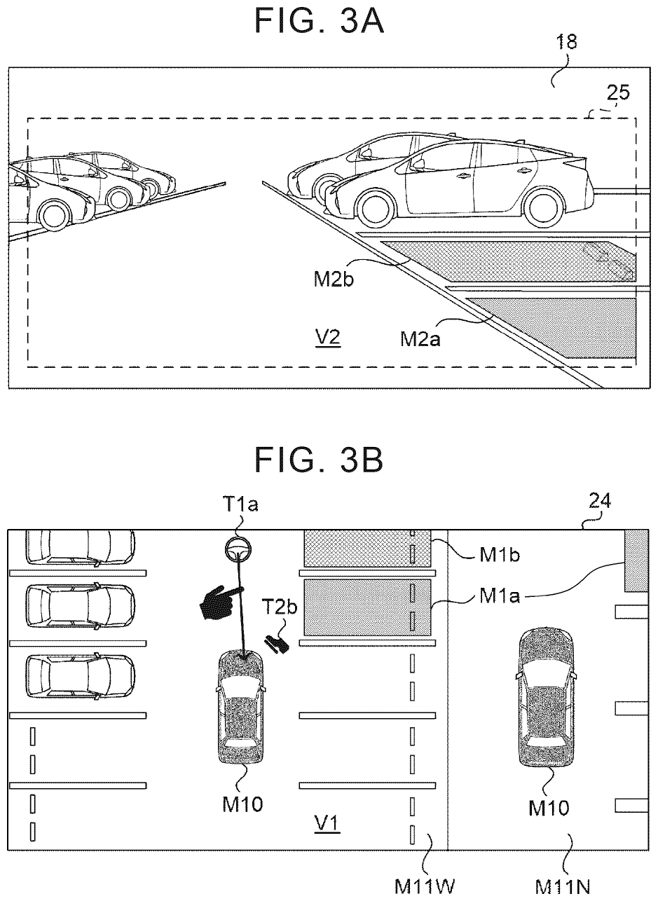

A vehicle display system S according to an embodiment will be described with reference to the drawings. In the vehicle 12 of the present embodiment, an instrument panel (not shown) is provided in a front portion of the vehicle cabin. Further, a windshield glass 18 (see FIG. 3A) is provided at a front end portion of the instrument panel. The windshield glass 18 extends in the vehicle vertical direction and the vehicle width direction and partitions the interior and the exterior of the vehicle cabin. Further, the vehicle 12 is provided with a vehicle display control device 10 constituting the vehicle display system S. The vehicle display control device 10 of the present embodiment is, for example, a display ECU (Electronic Control Unit) that performs various display controls.

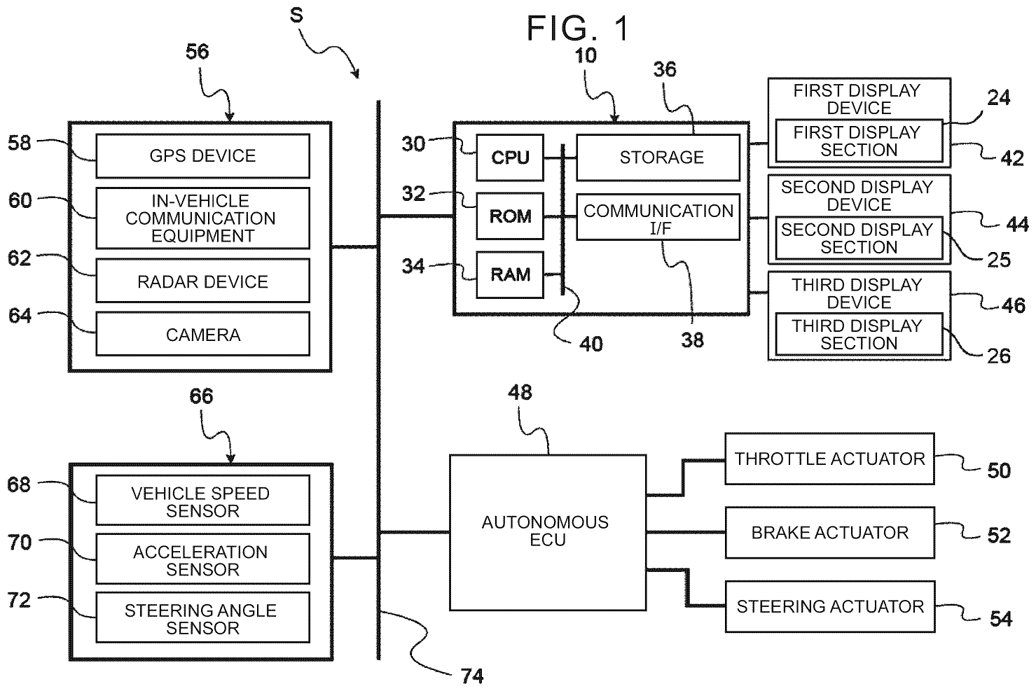

As illustrated in FIG. 1, the vehicle display system S includes a vehicle display control device 10, a peripheral information acquisition sensor group 56, a vehicle information acquisition sensor group 66, and an autonomous driving ECU 48, and is communicably connected to each other by a communication bus 74.

The vehicle display control device 10 includes a CPU (Central Processing Unit: processor) 30, a ROM (Read Only Memory) 32, a RAM (Random Access Memory) 34, a storage 36, and a communication interface (communication I/F) 38. The components are communicably connected to each other via an internal bus 40.

CPU 30 is a central processing unit that executes various programs and controls each unit. That is, CPU 30 reads the program from ROM 32 or the storage 36, and executes the program using RAM 34 as a working area. In addition, CPU 30 performs control of the above-described configurations and various arithmetic processes in accordance with programs recorded in ROM 32 or the storage 36.

The ROM 32 stores various programs and various data. RAM 34 temporarily stores a program/data as a working area. The storage 36 is a non-transitory recording medium configured by HDD (Hard Disk Drive) or SSD (Solid State Drive) and storing various programs including an operating system and various types of data. In the present embodiment, ROM 32 or the storage 36 stores a display program for performing a display process, a function control program for performing a function control process, and the like.

The communication I/F 38 is an interface for the vehicle display control device 10 to communicate with external servers and other devices. As the communication I/F 38, for example, standards such as CAN (Controller Area Network), Ethernet (registered trademark), LTE (Long Term Evolution), FDDI (Fiber Distributed Data Interface), and Wi-Fi (registered trademark) are used.

A first display device 42, a second display device 44, and a third display device 46 are connected to the vehicle display control device 10.

The first display device 42 displays an image on the display area V1 of the first display unit 24. The first display unit 24 of the present embodiment is constituted by a center display disposed in a central portion of the instrument panel in the vehicle width direction. The first display unit 24 includes a touch panel (not shown) and is configured to be able to detect a gesture manipulation on the display area V1. Then, the information of the gesture operation detected by the touch panel of the first display unit 24 is transmitted to the 25 vehicle display control device 10. The touch panel may be provided in the second display unit 25 and the third display unit 26. The display area V1 is an exemplary “first display area”.

The second display device 44 displays an image on the display area V2 of the second display unit 25. The second display unit 25 of the present embodiment is set on the vehicle upper side of the third display unit 26, which will be described later, and is 30 constituted by a projection surface projected by the second display device 44. The second display device 44 is a head-up display device provided on the vehicle front side of the instrument panel. The second display device 44 is configured to project images from the second display device 44, which is the head-up display device, to the second display unit 25 of the windshield glass 18 (see FIG. 3A). That is, the second display unit 25 is a part of the windshield glass 18 that is a projection surface of the head-up display device. The display area V2 is an exemplary “second display area”.

In the present embodiment, the second display device 44 is a so-called Augmented Reality Head UP Display (AR-HUD) configured to be capable of superimposing and displaying an image on the foreground of the vehicle 12. That is, the second display device 44 defines the angle of view based on the eye point of the occupant seated in the driver's seat and the imaging plane of the virtual range in the space in which the virtual image can be formed. The second display device 44 is configured to control the display position so that the positional relationship between the eye point of the occupant seated in the driver's seat, the superimposition target in the foreground, and the superimposition display is continuously maintained.

The third display device 46 displays an image on the display area V3 of the third display unit 26. The third display unit 26 of the present embodiment is a meter display located on the right side of the instrument panel in the vehicle. The third display unit 26 is connected to various meter devices mounted on the vehicle 12, and is provided at a position where the driver enters the field of view with his/her line of sight toward the front of the vehicle.

The peripheral information acquisition sensor group 56 includes a GPS (global positioning system) device 58, an in-vehicle communication device 60, a radar device 62, and a camera 64.

The radar device 62 is a sensor for detecting an object such as a pedestrian or another vehicle existing around the vehicle, and includes a plurality of radar devices having different detection ranges. For example, the radar device 62 may include a LIDAR (Light Detection and Ranging) or the like. Further, the radar device 62 may be configured to acquire a relative position and a relative speed between the detected object and the host vehicle. The camera 64 captures an image of the surroundings of the vehicle and outputs the captured image. For example, the camera 64 includes a front camera that photographs the front of the vehicle, a rear camera that photographs the rear of the vehicle, a side camera that photographs both the left and right of the vehicle, and the like.

The vehicle information acquisition sensor group 66 includes a vehicle speed sensor 68, an acceleration sensor 70, and a steering angle sensor 72. The vehicle speed sensor 68 directly or indirectly detects and outputs the speed of the vehicle. The acceleration sensor 70 directly or indirectly detects the acceleration of the vehicle and outputs the detected acceleration. The steering angle sensor 72 directly or indirectly detects and outputs the steering angle of the vehicle.

The autonomous driving ECU 34 is a control unit for performing an autonomous driving process of automatically driving the vehicle without an occupant operating the vehicle. The autonomous driving ECU 48 is electrically connected to the throttle actuator 50, the brake actuator 52, and the steering actuator 54. The throttle actuator 50 is an actuator that changes the throttle opening degree of the vehicle, and the brake actuator 52 is an actuator that changes the braking force generated by the braking device of the vehicle. The steering actuator 54 is an actuator that changes the amount of steering by the steering device of the vehicle.

Here, in the autonomous driving process by the autonomous driving ECU 34, the condition of the vehicle and its surroundings is determined based on the information obtained from the peripheral information acquisition sensor group 56 and the vehicle information acquisition sensor group 66. The autonomous driving ECU 34 controls the throttle actuator 50, the brake actuator 52, and the steering actuator 54 according to the surrounding conditions.

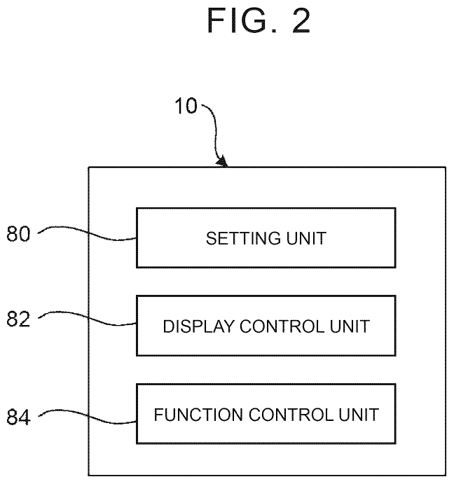

The vehicle display control device 10 realizes various functions using the above-described hardware resources. A functional configuration realized by the vehicle display control device 10 will be described with reference to FIG. 2. Although the vehicle 12 of the present embodiment includes a plurality of driving support functions, the vehicle 12 of the present embodiment includes at least the following driving support functions.

(1) Advanced Park (AP: Advanced Park). This function detects a parking position using an ultrasonic sonar, front, rear, left, and right cameras, and the like, and the driver instructs a parking position displayed on the multimedia to automatically place the parking garage, and also to support the exit from the parking state. The multimedia is, for example, the first display unit 24 of the present embodiment. The automatic operation operates the accelerator, brake, steering, and shift.

As illustrated in FIG. 2, the vehicle display control device 10 includes a setting unit 80, a display control unit 82, and a function control unit 84 as a functional configuration. The respective functional configurations are realized by CPU 30 reading and executing a program stored in ROM 32 or the storage 36.

The setting unit 80 has a function of setting a recommended parking position. The setting unit 80 of the present embodiment detects the parking position around the vehicle 12, and sets the first recommended area and the second recommended area according to the detected state of the parking position. Here, the first recommended area indicates the most recommended parking position, and the second recommended area indicates the parking position recommended next to the parking position indicated by the first recommended area. As an example, the setting unit 80 sets a parking position where no parked vehicle is present on either side of the left or right side as a first recommended area, and sets a parking position where a parked vehicle is present on at least one side as a second recommended area. The setting unit 80 may set a recommended parking position based on a situation of the entire parking lot (for example, a position of an adjacent building, a position of an entrance of a parking lot, and the like). In addition, the setting unit 80 may set a plurality of first recommended areas and a plurality of second recommended areas. Further, the setting unit 80 may set the third recommended region and the subsequent regions indicating the parking position recommended next to the parking position indicated by the second recommended region.

The display control unit 82 has a function of displaying information indicating a recommended parking position. The display control unit 82 of the present embodiment causes the first display unit 24 and the second display unit 25 to display information indicating the recommended parking position set by the setting unit 80. Note that the display control unit 82 may cause the third display unit 26 to display some or all of the information to be displayed on the first display unit 24.

In addition, the display control unit 82 has a function of displaying a telltale indicating an operation state of the operation function in accordance with the detected gesture operation. For example, the display control unit 82 displays a telltale indicating an operation state of an operation function of the vehicle 12 in accordance with a slide operation detected by a touch panel provided on the first display unit 24. Here, the operation function includes driving operations such as a steering function indicating a steering operation, an acceleration/deceleration function indicating an operation of an accelerator and a brake, and the like. The operating status of the operating function includes a manual operation mode in which the occupant performs the driving operation, and an automatic operation mode in which the autonomous driving ECU 48 performs the driving operation. Hereinafter, the tellurium indicating the operating state of the operation function is also simply referred to as “tellurium”. The telltale is an example of a “functional image”.

The function control unit 84 has a function of changing the operating state of the operation function. The function control unit 84 of the present embodiment switches between the manual operation mode and the automatic operation mode of the operation function in accordance with a gesture operation on the telltale.

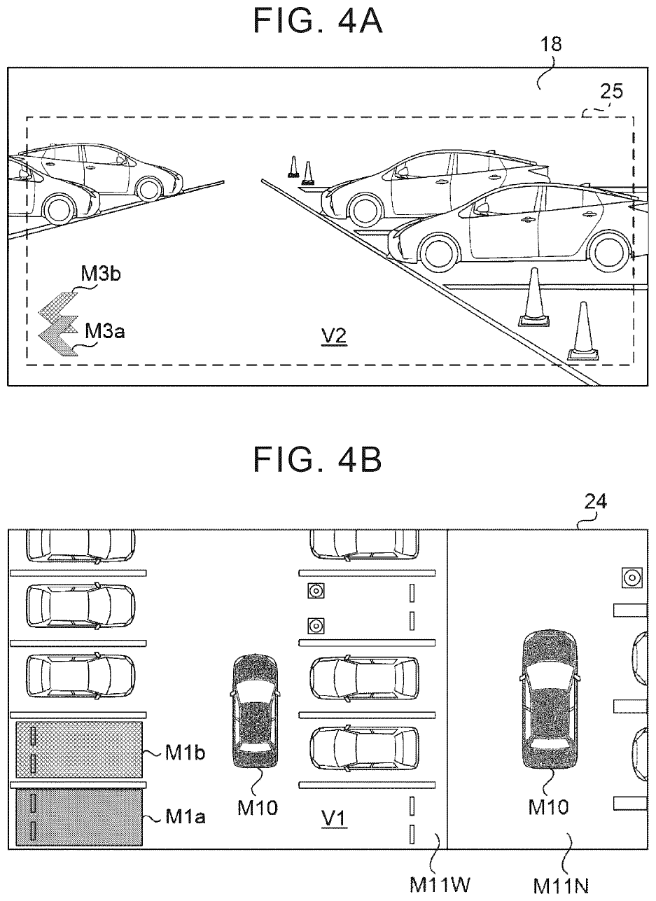

Next, referring to FIG. 3A, FIG. 3B, FIG. 4A, and FIG. 4B, the display area V1 of the first display unit 24 according to the present embodiment, and a display example displayed on the display area V2 of the second display unit 25 will be described. FIGS. 3A and 3B show a case where parking is attempted by a function of the advanced park of the vehicle 12 at a recommended parking position. In addition, FIGS. 4A and 4B are illustrations when the vehicles 12 are slowly traveling along one-way roads in the parking lot. Note that the display example shown in FIG. 3A is displayed on the display area V2, and the display example shown in FIG. 3B is displayed on the display area V1. Further, a display example shown in FIG. 4A is displayed on the display area V2, and a display example shown in FIG. 4B is displayed on the display area V1. In addition, for convenience of explanation, only a part of the windshield glass 18 is illustrated in FIGS. 3A and 4A.

As shown in FIG. 3A, a foreground, which is a scene in front of the vehicle 12 through the windshield glass 18, is visible in the display area V2. Further, an area marker M2 indicating a recommended parking position is displayed in the display area V2. The area marker M2 is AR (Augmented Reality) images superimposed on the foreground of the vehicles 12. AR images include 2D images and 3D images. The area marker M2 includes an area marker M2a corresponding to an area image M1a to be described later and an area marker M2b corresponding to an area image Mlb to be described later. The area marker M2 is an example of “area information”.

The area marker M2a is displayed in green so as to indicate a range of a parking position located at the front of the vehicle 12, which is diagonally forward of the right, and which can be displayed on the display area V2. Further, the area marker M2b is displayed in orange so as to indicate a range of the parking position located at the second position from the front that can be displayed on the display area V2 on the right-diagonal front side of the vehicle 12. Green is an example of a “specific color”. The orange color is an example of “a color different from a specific color”.

As shown in FIG. 3B, the display area V1 displays a host vehicle image M10 simulating the vehicle 12, a bird's-eye view image M11 simulating the surrounding condition of the vehicle 12, and area image M1 indicating a recommended parking position. The bird's-eye view image M11 includes bird's-eye view image M11W that simulates the surrounding situation of a wide area and bird's-eye view image M11N that simulates the surrounding situation of a narrow area. Further, the area image M1 includes area image M1a indicating the first recommended region and area image Mlb indicating the second recommended region. Then, in the display area V1, a telltale T1 indicating that the operation function is the auto operation mode and a telltale T2 indicating that the operation function is the manual operation mode are displayed. The telltale T1 includes the telltale T1a corresponding to the steering function and the telltale Tlb corresponding to the acceleration/deceleration function. Further, the telltale T2 includes a telltale T2a corresponding to the steering function and a telltale T2b corresponding to the acceleration/deceleration function. Note that a solid arrow in FIG. 3B indicates the orientation and trajectory of the detected slide manipulation. In addition, the vertical direction in the display area V1 of the present embodiment coincides with the front-rear direction of the host vehicle image M10, and the horizontal direction in the display area V1 coincides with the horizontal direction of the host vehicle image M10. The bird's-eye view image M11 is an exemplary “surrounding image”.

The host vehicle image M10 is displayed by being superimposed on the bird's-eye view image M11 at a position substantially at the center of the bird's-eye view image M11. The host vehicle image M10 of the present embodiment is displayed so as to be superimposed on any of the bird's-eye view image M11W, M11N. The bird's-eye view image M11W is an image simulating a peripheral state in which a range of about 12 m in the front-rear direction and a range of about 20 m in the left-right direction are looked down from directly above around the vehicle 12, and is displayed in an area of about 70% from the left direction to the right direction of the display area V1. The bird's-eye view image M11N is an image simulating a peripheral state in which a range of about 10 m in the front-rear direction and a range of about 7 m in the left-right direction are looked down from directly above around the vehicle 12, and is marked in the remaining area of the display area V1. Note that the bird's-eye view image M11N may be configured to synthesize and display an image actually captured by the cameras 64 of the vehicles 12 instead of an image imitating a surrounding situation.

The area image M1a is displayed in green in an area that is diagonally ahead of the host vehicle image M10 and indicates a parking position closest to the host vehicle image M10. Further, the area image Mlb is displayed in orange in an area that is diagonally ahead of the host vehicle image M10 and indicates the second nearest parking position from the host vehicle image M10. The telltale T1 is displayed in gray at a position in the upper center of the bird's-eye view image M11W. Further, the telltale T2 is displayed in dark green at a position near the front of the host vehicle image M10 of the bird's-eye view image M11W. The position in the vicinity of the front of the host vehicle image M10 is a position in front of the host vehicle image M10 and within a predetermined area. In the present embodiment, the telltale T1a is displayed at the center of the upper portion of the bird's-eye view image M11W, and the telltale T2b is displayed at a position near the front of the host vehicle image M10.

As described above, the area image M1a is displayed in green on the display area V1, and the area marker M2a is displayed in green on the display area V2. Thus, the first recommended area in the display area V1 and the first recommended area in the foreground visible through the display area V2 are shown in association with each other. Further, the area image Mlb is displayed in orange on the display area V1, and the area marker M2b is displayed in orange on the display area V2. The “y” indicates a second recommended area in the display area V1 and a second recommended area in the foreground visible through the display area V2 in association with each other. The telltale T1a and the telltale T2b are displayed to indicate that the advanced park function of the vehicle 12 is activated. Further, it is shown that the steering function is changed from the autonomous operation mode to the manual operation mode by detecting a sliding operation toward the host vehicle image M10 with respect to the telltale T1a.

Next, differences between FIGS. 4A and 4B and FIGS. 3A and 3B will be described. The rest of the configuration is the same as that of the above-described FIGS. 3A and 3B, and the detailed explanation thereof is omitted.

As shown in FIG. 4A, a direction marker M3 indicating a direction of a recommended parking position is displayed in the display area V2. The direction marker M3 is AR images superimposed on the foreground of the vehicles 12. The direction marker M3 includes a direction marker M3a corresponding to the area image M1a and a direction marker M3b corresponding to the area marker M2a. Note that the up-down direction in the display area V2 of the present embodiment coincides with the up-down direction of the vehicle 12, and the left-right direction in the display area V2 coincides with the left-right direction of the vehicle 12. The direction marker M3 is an example of “area information”.

The direction marker M3a is displayed in green at the lower left corner of the display area V2 with a left direction slightly lower than the direction marker M3b. Further, the direction marker M3b is displayed in orange at the lower left corner of the display area V2, indicating the left direction slightly above the direction marker M3a.

As described above, the direction marker M3a, M3b is displayed at the lower left corner of the display area V2 to indicate the left direction, thereby indicating that the first recommended area and the second recommended area exist diagonally behind the left side of the vehicle 12. Further, in the lower left corner of the display area V2, the direction marker M3b is displayed slightly above the direction marker M3a to indicate that there is a second recommended area and a first recommended area in order from the left obliquely rearward side of the vehicle 12 and closer to the vehicle 12.

As shown in FIG. 4B, the area image Mlb, M1a is displayed in order from the side closer to the host vehicle image M10 in the area indicating the left-diagonally rearward parking position of the host vehicle image M10.

As described above, the area image M1a is displayed in green on the display area V1, and the direction marker M3a is displayed in green on the display area V2. In this case, the first recommended area in the display area V1 and the orientation of the first recommended area outside the range of the display area V2 are indicated in association with each other. Further, the area image Mlb is displayed in orange on the display area V1, and the direction marker M3b is displayed in orange on the display area V2. Thus, the second recommended area in the display area V1 and the orientation of the second recommended area outside the range of the display area V2 are shown in association with each other.

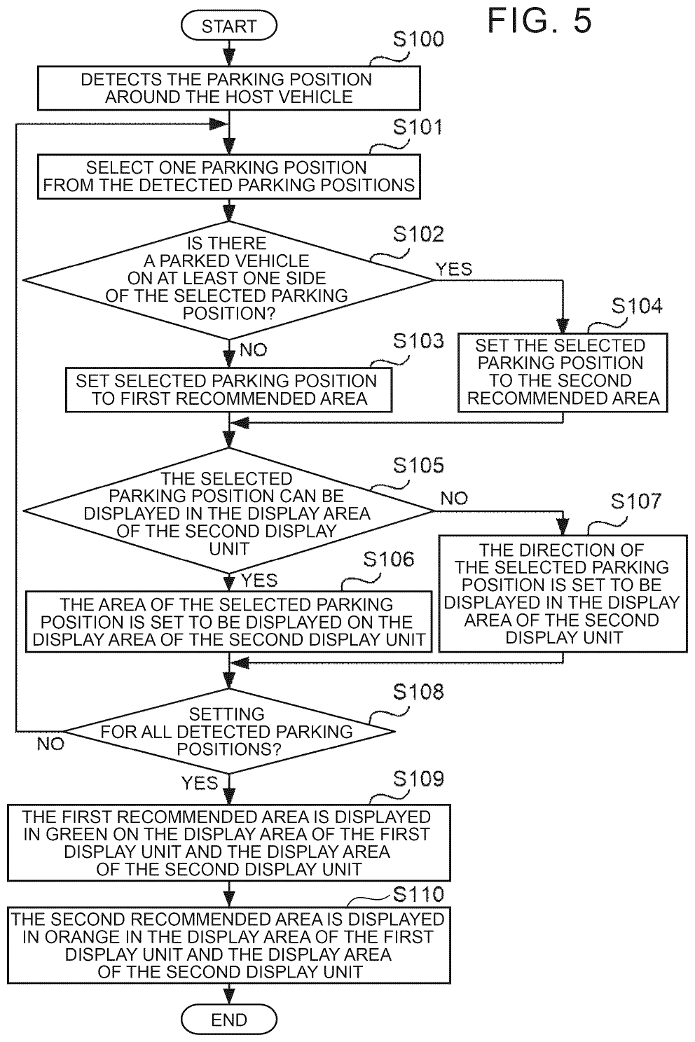

FIG. 5 is a flowchart illustrating an example of a flow of a display process according to the present embodiment. The display process of the present embodiment is, for example, a process that is repeatedly executed after the vehicle 12 enters the parking lot until the parking is completed.

In S100 of FIG. 5, CPU 30 detects a parking position around the host vehicle. Specifically, CPU 30 detects a parking position that can be parked around the vehicles 12. CPU 30 of the present embodiment preferentially detects a parking position existing in the traveling direction of the vehicles 12. That is, CPU 30 detects the parking position behind the vehicle 12 when the parking position is not detected in front of the vehicle 12.

In S101, CPU 30 selects one parking position from the detected parking positions.

In S102, CPU 30 determines whether parked vehicles are present on at least one side of the selected parking position. If CPU 30 determines that there are parked vehicles on at least one side of the selected parking position (S102: YES), it proceeds to S104. On the other hand, if CPU 30 determines that there are no parked vehicles on at least one side of the selected parking position (S102: NO), it proceeds to S103.

In S103, CPU 30 sets the selected parking position to the first recommended area.

In S104, CPU 30 sets the selected parking position to the second recommended area.

In S105, CPU 30 determines whether or not the selected parking position is a range that can be displayed on the display area V2 of the second display unit 25. When CPU 30 determines that the selected parking position is a displayable area on the second display unit 25 (S105: YES), the process proceeds to S106. On the other hand, when CPU 30 determines that the selected parking position is not displayable on the second display unit 25 (S105: NO), the process proceeds to S107.

In S106, CPU 30 sets the area of the selected parking position to be displayed on the display area V2 of the second display unit 25. Specifically, CPU 30 sets the area marker M2 to be displayed in an area indicating the selected parking position.

In S107, CPU 30 sets the orientation of the selected parking position to be displayed on the display area V2 of the second display unit 25. Specifically, CPU 30 is set so that the direction marker M3 is displayed in an area indicating the selected parking position.

In S108, CPU 30 determines whether all detected parking positions have been set. If it is determined that all the detected parking positions have been set (S108: YES), CPU 30 proceeds to S109. On the other hand, if it is determined that all the detected parking positions have not been set (S108: NO), CPU 30 returns to S101.

In S109, CPU 30 displays the first recommended area in green on the display area V1 of the first display unit 24 and the display area V2 of the second display unit 25. Specifically, CPU 30 displays the area image M1a on the display area V1 of the first display unit 24, and displays the area marker M2a or the direction marker M3a on the display area V2 of the second display unit 25 (see FIG. 3A, FIG. 3B, FIG. 4A, and FIG. 4B).

In S110, CPU 30 displays the second recommended area in orange on the display area V1 of the first display unit 24 and the display area V2 of the second display unit 25. Specifically, CPU 30 displays the area image Mlb on the display area V1 of the first display unit 24, and displays the area marker M2b or the direction marker M3b on the display area V2 of the second display unit 25 (see FIG. 3A, FIG. 3B, FIG. 4A, and FIG. 4B). Then, CPU 30 ends the displaying process.

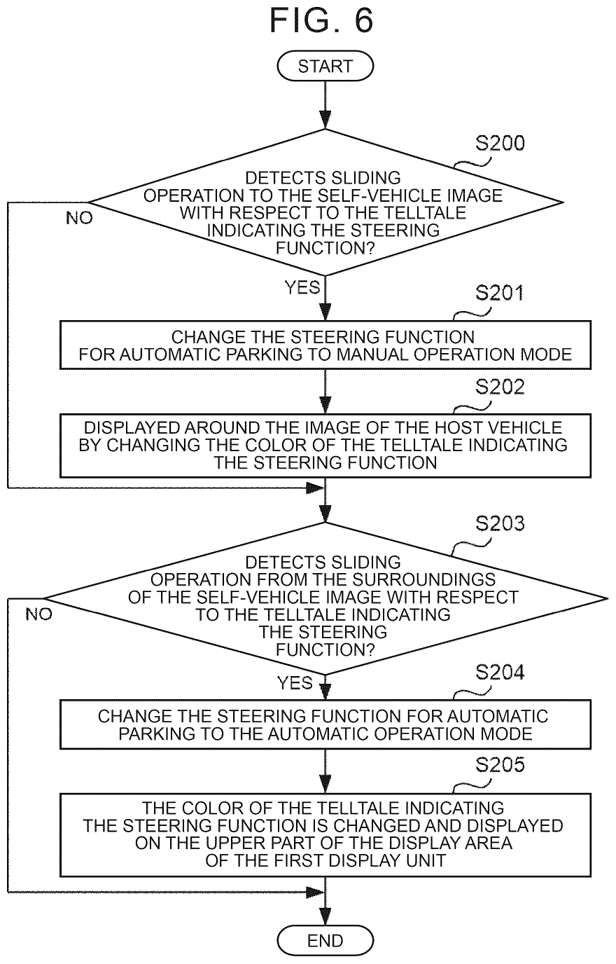

FIG. 6 is a flowchart illustrating an example of the flow of the function control processing according to the present embodiment. The function control process of the present embodiment is, for example, a process that is repeatedly executed from the time when the advanced park function of the vehicle 12 is activated to the time when the parking of the vehicle 12 is completed.

In S200 of FIG. 6, CPU 30 determines whether or not a slide manipulation to the host vehicle image M10 with respect to the telltale indicating the steering function has been detected. Specifically, CPU 30 determines whether or not a slide manipulation with respect to the telltale T1a to the host vehicle image M10 has been detected (refer to FIG. 3B). CPU 30 proceeds to S201 when it is determined that the slide manipulation to the host vehicle image M10 with respect to the telltale indicating the steering function is detected (S200: YES). On the other hand, if it is determined that CPU 30 has not detected a slide manipulation to the host vehicle image M10 with respect to the telltale indicating the steering function (S200: NO), the process proceeds to S203.

In S201, CPU 30 changes the steering function when the vehicle is automatically parked to the manual operating mode.

In S202, CPU 30 changes the color of the telltale indicating the steering function to be displayed around the host vehicle image M10. Specifically, CPU 30 displays the telltale T2a at a position near the front of the host vehicle image M10.

In S203, CPU 30 determines whether or not a slide manipulation from the periphery of the host vehicle image M10 with respect to the telltale indicating the steering function has been detected. Specifically, CPU 30 determines whether or not a slide manipulation from a position near the front of the host vehicle image M10 with respect to the telltale T2a has been detected. CPU 30 proceeds to S204 when it is determined that the slide manipulation from the surroundings of the host vehicle image M10 with respect to the telltale indicating the steering function is detected (S203: YES). On the other hand, when it is determined that CPU 30 has not detected a slide manipulation from the surroundings of the host vehicle image M10 with respect to the telltale indicating the steering function (S203: NO), the function control process ends.

In S204, CPU 30 changes the steering function at the time of automatic parking to the automatic operating mode.

In S205, CPU 30 changes the color of the telltale indicating the steering function and displays it on the top of the display area V1 of the first display unit 24. Specifically, CPU 30 causes the telltale T1a to be displayed at a position in the center of the upper portion of the bird's-eye view image M11W displayed on the display area V1 of the first display unit 24. Then, CPU 30 ends the function control process.

### SUMMARY OF THIS EMBODIMENT

The vehicle display control device 10 of the present embodiment causes the bird's-eye view image M11 and the area image M1 to be displayed on the display area V1 of the first display unit 24 provided around the driver's seat of the vehicle 12. Further, the vehicle display control device 10 of the present embodiment causes the display area V2 of the second display unit 25 to display the area marker M2 corresponding to the area image M1 superimposed on the foreground of the vehicle 12. Therefore, according to the vehicle display control device 10 of the present embodiment, it is possible to allow the occupant to correctly recognize the recommended actual parking position.

The vehicle display control device 10 of the present embodiment displays the area image M1 displayed in the display area V1 and the area marker M2 and the direction marker M3 displayed in the display area V2 in the same color. Therefore, according to the vehicle display control device 10 of the present embodiment, the occupant can easily understand the correspondence between the area images M1 displayed in the different display areas and the area marker M2 and the direction marker M3.

The vehicle display control device 10 of the present embodiment causes the area images M1a, the area marker M2a, and the direction marker M3a indicating the first recommended area, which is the parking position where no parked vehicle is present on either side, to be displayed in green. Further, the vehicle display control device 10 of the present embodiment displays, in orange, the area images Mlb, the area marker M2b, and the direction marker M3b indicating the second recommended area, which is the parking position where the parked vehicle is present at least on the side. Therefore, according to the vehicle display control device 10 of the present embodiment, the occupant can easily understand the correspondence relationship of the information indicating the parking positions having different recommended degrees displayed in different display areas.

When the parking position in which the vehicle 12 can be parked is outside the range in which the parking position can be displayed on the display area V2, the vehicle display control device 10 of the present embodiment causes the display area V2 to display a direction marker M3 indicating the direction in which the parking position is present. Therefore, according to the vehicle display control device 10 of the present embodiment, it is possible to guide the parking position deviated from the displayable range superimposed on the foreground of the vehicle 12.

The vehicle display control device 10 of the present embodiment changes the operating status of the steering function by detecting a sliding operation on the telltale indicating the steering function, and moves the display of the telltale displayed on the display area V1 in accordance with the sliding operation. Therefore, according to the vehicle display control device 10 of the present embodiment, the occupant can easily switch the operating state of the operation function at the time of automatic parking.

In addition, the configuration of the vehicle display control device 10 described in the above embodiment is an example, and may be changed in accordance with a situation within a range not departing from the gist. The flow of the processing of the program described in the above embodiment is also an example, and unnecessary steps may be deleted, new steps may be added, or the processing order may be changed without departing from the gist.

In the above-described embodiment, the information processing program is stored (installed) in the storage in advance, but the present disclosure is not limited thereto. The program may be provided in a form recorded in a recording medium such as CD-ROM (Compact Disc Read Only Memory), DVD-ROM (Digital Versatile Disc Read Only Memory), and USB (Universal Serial Bus). The program may be downloaded from an external device via a network. Further, the present disclosure is also applicable to programs and program products.

What is claimed is:

1. A vehicle display control device comprising a display control unit that displays a peripheral image simulating a peripheral situation of a host vehicle and an area image indicating an area that enables the host vehicle to be parked on the peripheral image in a first display area provided around a driver's seat of the host vehicle, and that displays area information that is information corresponding to the area image in correspondence with the peripheral situation of the host vehicle in a second display area provided at a location different from the first display area around the driver's seat.

2. The vehicle display control device according to claim 1, wherein the display control unit displays the area image and the area information in at least partially the same manner.

3. The vehicle display control device according to claim 2, wherein:
the display control unit displays, in a specific color, the area image indicating a first recommended area in which parking of the host vehicle is recommended and the area information corresponding to the area image indicating the first recommended area, the first recommended area being determined based on information about the peripheral situation from among a plurality of areas; and
the display control unit displays, in a color different from the specific color, the area image indicating a second recommended area in which parking of the host vehicle is recommended and the area information corresponding to the area image indicating the second recommended area, the second recommended area being different from the first recommended area.

4. The vehicle display control device according to claim 1, wherein the display control unit displays a marker indicating a direction in which the area is present in the second display area when the area is located outside a displayable range of the second display area.

5. The vehicle display control device according to claim 1, further comprising a function control unit that controls a state of an operation function related to parking of the host vehicle based on an operation on a function image indicating the operation function, wherein the display control unit displays the function image in the first display area, and moves display of the function image in accordance with an operation on the function image.
